(19) United States
(12) Patent Application Publication
(10) Pub. No.: US 2024/0104055 A1
(43) Pub. Date: Mar. 28, 2024

(54) METHOD AND SYSTEM OF INTELLIGENTLY GENERATING A TITLE FOR A GROUP OF DOCUMENTS

(71) Applicant: Microsoft Technology Licensing, LLC, Redmond, WA (US)

(72) Inventor: Julia S McANALLEN, Seattle, WA (US)

(73) Assignee: Microsoft Technology Licensing, LLC, Redmond, WA (US)

(21) Appl. No.: 17/950,475

(22) Filed: Sep. 22, 2022

(51) Int. Cl. G06F 16/16; G06F 16/35

(52) U.S. Cl. CPC G06F 16/164; G06F 16/35

(57) ABSTRACT

A system and method automatically generating a title for a cluster of documents includes accessing a plurality of documents that have been categorized as belonging to a document cluster and providing the plurality of documents as an input to a trained title generating machine-learning (ML) model. The trained title generating ML model is trained for generating a title for a document and provides a titles for each of the plurality of documents. An embedding is created for the generated titles and then an embedding is generated for the document cluster. A similarity between the embeddings for the titles and embedding for the document cluster is measured to identify titles that are more similar to the embedding for the document cluster and based on the similarity one or more titles are selected as title candidates for the document cluster and provided as an output.

### BACKGROUND

With the increase in the number of electronic content created by users, many enterprises that use or analyze such content, have to utilize mechanisms for organizing the content to enable to process and/or analyze the content. Some enterprises use clustering mechanisms for grouping electronic content such as user feedbacks into clusters based on similarities. For example, the content may be grouped based on inferred or explicitly stated topics. While such clustering makes analyzing the content more efficient by providing fewer categories of content to examine, when the number of clusters is large and/or when new dusters are continuously created, reviewing the clusters still takes a large amount of time and resources. This is made further challenging, when the clusters do not have a title by which they can be identified.

Generating a title for a group of content, however, is a time-consuming and challenging task. When done manually, it requires a user to examine multiple content items in each cluster to identify a recurring theme and then create a title based on the identified theme. This is not only time-consuming, but also requires a specific skill set. Some automatic title generation algorithms have been developed that can automatically generate a title for a document. However, the currently used mechanisms for title generation either extract phrases directly from the document to use as the title or try to match the content with documents having tides to infer the title based on a match. Extracting titles directly from the document, however, does not always result in accurate titles, particularly for a group of documents, because often the recurring theme is not directly mentioned in the content. Moreover, comparing the content with documents that already have titles to identify a match may result in inaccurate titles, as the main theme or topic of the document may not have a direct match with titled documents.

Hence, there is a need for improved systems and methods of intelligently generating a title for a group of documents.

### SUMMARY

In one general aspect, the instant disclosure presents a data processing system having a processor and a memory in communication with the processor wherein the memory stores executable instructions that, when executed by the processor, cause the data processing system to perform multiple functions. The functions include accessing a plurality of documents that have been categorized as belonging to a document cluster and providing the plurality of documents as an input to a trained title generating machine-learning (ML) model. The trained title generating ML model is trained for generating a title for a document and provides a titles for each of the plurality of documents. An embedding is created for the generated titles and then an embedding is generated for the document cluster. A similarity between the embeddings for the titles and embedding for the document cluster is measured to identify titles that are more similar to the embedding for the document cluster and based on the similarity one or more titles are selected as title candidates for the document cluster and provided as an output.

In yet another general aspect, the instant disclosure presents a method for automatically generating a title for a document cluster. In some implementations, the method includes accessing a plurality of documents that have been categorized as belonging to a document cluster and providing the plurality of documents as an input to a trained title generating machine-learning (ML) model. The trained title generating ML model is trained for generating a title for a document and provides a titles for each of the plurality of documents. An embedding is created for the generated titles and then an embedding is generated for the document cluster. A similarity between the embeddings for the titles and embedding for the document cluster is measured to identify titles that are more similar to the embedding for the document cluster and based on the similarity one or more titles are selected as title candidates for the document cluster and provided as an output.

In a further general aspect, the instant application describes a non-transitory computer readable medium on which are stored instructions that when executed cause a programmable device to perform functions of accessing a document, the document including content from a plurality of shorter documents, the shorter documents being documents that have been identified as belonging to a document cluster, providing the document as an input to a trained title generating ML model, the trained title generating ML model being trained for generating a title for a document that includes a plurality of shorter documents that belong to the document cluster, receiving a title from the trained title generating ML model as an output, and providing the title as a cluster title for the document cluster.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example of some of the elements of a title generating system upon which aspects of this disclosure may be implemented.

FIG. 3 depicts how the title generating model used by the title generating system is trained.

FIG. 4A is a flow diagram depicting an exemplary method for automatically generating a title for a cluster of documents.

FIG. 4B is a flow diagram depicting an alternative method for automatically generating a title for a cluster of documents.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

To enable users and enterprises to analyze and utilize electronic content such as text, mechanisms for clustering such content have been developed. Common algorithms for clustering unlabeled text documents include Latent Dirichlet Allocation (LDA) topic modeling, K-means clustering and Density-Based Spatial Clustering of Applications with Noise (DBSCAN). While there are differences in the specifics of different clustering and topic modeling algorithms, most are used for grouping together documents with similar themes or topics. The documents can be long documents or documents consisting of one or more phrases. For example, the following six unlabeled text segments may each be considered a document.
A. A food processor is required for this recipe.
B. Thailand has emerged as a popular travel destination.
C. A new movie starring Bradley Cooper is out this weekend.
D. Film attendance has increased this year but has not yet reached pre-pandemic levels.
E. Olive oil is the first ingredient for the marinade.
F. Skip long lines at airports with TSA Precheck.

Applying a clustering algorithm to the above documents would result in 3 different clusters. A first cluster would include documents A and E. A second cluster would include documents B and F and a third cluster would include documents C and D. A person reviewing the clusters may provide the title of cooking for the first cluster, travel for the second cluster and film for the third cluster. While it may be easy for a human to review 3 clusters of documents each containing 2 documents, in the real world, clustering algorithms are used for much larger datasets (e.g., containing thousands or millions of documents). As a result, the task of reading and generating cluster titles becomes an increasing time-consuming and labor-intensive task. Because of the extensive use of clustering approaches in both business and academic environments and the challenges involved in manually generating titles for clusters, a mechanism is needed for automatically generating titles for clusters of documents. However, currently available mechanisms for automatic title generation either do not apply to generating titles for clusters or suffer from a number of drawbacks.

A common approach for generating a title for a document involves extracting top keywords or spans (e.g., contiguous phrases in the document) from the document to generate the title. This is a simple and straightforward approach that is limited in its ability to capture the contents of a cluster broadly. For example, if a cluster consisted of the following list of words: banana, orange, grapes, watermelon, and cherry, a human may generate the cluster title as “fruit.” However, the word “fruit” does not appear in any of the inputs. As a result, the keyword or span-based approaches would not be able to generate the title correctly, as the title would have to be extracted directly from one of the documents. Thus, the scope of possible titles for the keyword or span-based approaches is always limited to words that appear in the input documents. Another approach for generating titles includes the use of a knowledge base network (e.g., Wikipedia articles), as a knowledge base for comparison. In this approach, clusters of documents are matched via similarity measurements to titled documents in a knowledge network. The title of a titled document that is most similar to the cluster is then selected as the title of the cluster. This approach might resolve the issues identified for the fruit cluster above, but it still limits the possible titles to the finite list of titled documents (e.g., Wikipedia page titles). If clusters closely match existing titled documents, the selected titles may accurately capture the topic of the cluster. However, when the clusters are not closely aligned with a titled document, the titles could be so inaccurate to be confusing and counter-productive to the task of interpreting the text clusters. Thus, there exists a technical problem of current mechanisms for generating titles for groups of documents being inefficient and limited in their ability to generate accurate titles.

To address these technical problems and more, in an example, this description provides technical solutions for intelligently generating titles for groups of documents. This involves training a machine-learning (ML) model to generate a title for multiple documents in a document cluster. The ML model may be a pretrained model such as a pretrained encoder-decoder deep learning model. The training may involve using a training data set that includes sets of labeled (e.g., titled) documents (e.g., short texts). Once the model is trained, it is used to generate a title for multiple documents in the document cluster (e.g., all documents in the cluster or a subset of the documents in the cluster). The generated titles are then converted to embeddings. Those embeddings are compared against an averaged embedding for the cluster as a whole to measure the similarity between each title embedding and the cluster embedding and identify a top number (e.g., the top 1) of similar candidates as the title for the cluster. In this manner, the technical solutions provide an automatic title generation system that can quickly and efficiently generate accurate titles for a group of documents by taking into the content of the document and the overall theme of the cluster. This minimizes the amount of manual intervention required for generating accurate titles for a cluster of documents, thus increasing the efficiency of title generation for document clusters. Furthermore, the technical solution generates accurate titles that take into account both the content of each document and the overall topic of the cluster.

As will be understood by persons of skill in the art upon reading this disclosure, benefits and advantages provided by such implementations can include, but are not limited to, a technical solution to the technical problems of lack of mechanisms for efficient and accurate generation of titles for groups of documents. The technical solutions enable automatic generation of titles that accurately capture a cluster and are not limited to currently available titles and exact content of the documents. This not only eliminates or reduces the need for human intervention, but also results in higher quality titles that accurately capture the cluster topic. Furthermore, because the technical solution does not involve directly extracting words or phrases from the documents, it reduces the likelihood of user data being included in the generated titles. This is advantageous as it improves privacy in title generation. In this manner, the technical solution minimizes manual input and improves the operation and efficiency of computer systems used in analyzing, processing and reviewing document clusters. The technical effects at least include (1) improving the efficiency and accuracy of generating titles for clusters of documents; (2) improving the efficiency of using computing systems to analyze, process and review clusters of documents; and (3) improves privacy by reducing the likelihood of including the text from the underlying documents in the title.

As used herein, the terms “electronic content,” or “document” may refer to a separate text content of any length (e.g., from a phrase of one or more words to a few paragraphs). For example, any individual user feedback (e.g., user reviews or user feedbacks of products) may be referred to as a document or an electronic content. The term “cluster,” or “group” may refer to a group of documents that are classified as belonging to the same category. The documents may be grouped or clustered by using known clustering techniques.

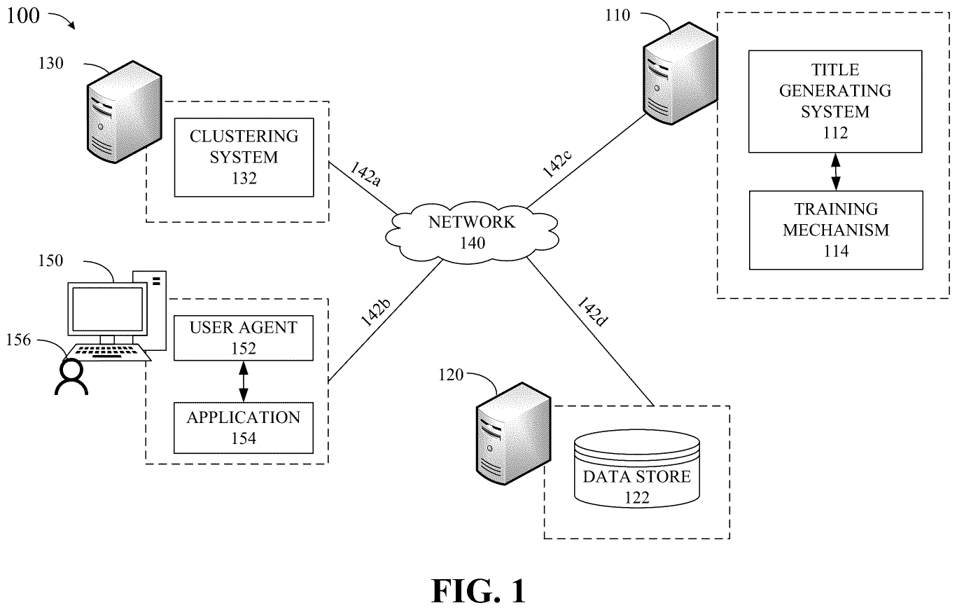

FIG. 1 illustrates an example system 100, upon which aspects of this disclosure may be implemented. The system 100 includes a server 110, which itself includes a title generating system 112 and a training mechanism 114. While shown as one server, the server 110 may represent a plurality of servers that work together to deliver the functions and services provided by each system or application included in the server 110. The server 110 may operate as a cloud-based server for title generating services for one or more applications such as application 154. The server 110 may also operate as a shared resource server located at an enterprise accessible by various computer client devices such as a client device 150. It should be understood that the system 100 depicted in FIG. 1 is provided by way of example and the system 100 and/or further systems contemplated by this present disclosure may include additional and/or fewer components, may combine components and/or divide one or more of the components into additional components, etc. For example, the system 100 may include any number of title generating servers 110, clustering servers 130, client devices 150, or networks 140.

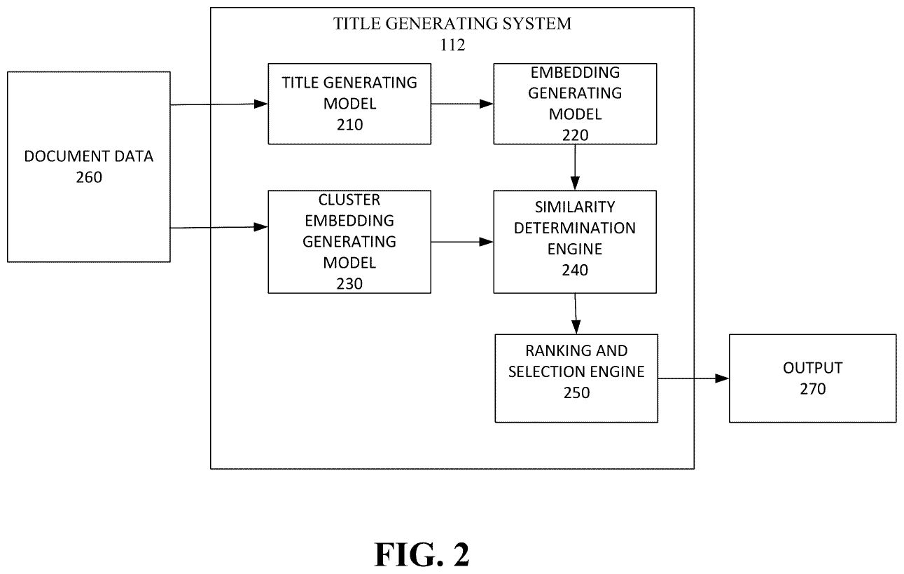

The server 110 includes and/or executes the title generating system 112, which receives a set of documents in a given cluster, analyzes the documents and automatically generates a title for the cluster. To achieve this, the title generating system 112 may generate a title for each document in the cluster and generate an embedding for each generated title. Separately, the title generating system 112 may generate an average embedding for the cluster of documents as a whole. The title generating system 112 may then compare the generated title embeddings with the generated average embedding to identify generated titles that are more similar to the overall embedding for the cluster. The most similar titles (e.g., one or more of the top similar titles) are then selected as the title for the cluster. In an alternative implementation, the title generating system receives a document containing the plurality of the document in the cluster or combines the individual documents in the cluster to generate one or more concatenated document. The title generating system 112 then generates a title for each of the concatenated documents. When all of the individual documents in the cluster are concatenated into one concatenated document, the title generating system 112 generates a title for the concatenated document. The title is generated by taking into account the individual documents present in the concatenated document. As a result, an average embedding for the whole cluster does not need to be generated. If the individual documents are concatenated into multiple documents, and a title is generated for each concatenated document, then an average embedding for the cluster is generated and compared with the titles for each concatenated document to select the title for the cluster. At least some of the actions performed by the title generating system 112 are achieved by utilizing one or more ML models, as discussed in greater detail with respect to FIG. 2.

One or more ML models implemented by the title generating system 112 are trained by the training mechanism 114. The training mechanism 114 may use training data sets stored in the data store 122 to provide initial and ongoing training for each of the models. Alternatively, or additionally, the training mechanism 114 uses training datasets from elsewhere. In some implementations, the training mechanism 114 uses labeled training data to train one or more of the models via deep neural network(s) or other types of ML models. The initial training may be performed in an offline stage.

As a general matter, the methods and systems described herein may include, or otherwise make use of one or more ML model to generate titles for documents and/or generate embeddings for text. ML generally involves various algorithms that can automatically learn over time. The foundation of these algorithms is generally built on mathematics and statistics that can be employed to predict events, classify entities, diagnose problems, and model function approximations. As an example, a system can be trained using data generated by a ML model in order to identify patterns in documents, determine associations between various words and title labels, and generate titles. Such training is made following the accumulation, review, and/or analysis of data over time. Such data is configured to provide the ML algorithm (MLA) with an initial or ongoing training set. In addition, in some implementations, a user device can be configured to transmit data captured locally during use of relevant application(s) to a local or remote ML algorithm and provide supplemental training data that can serve to fine-tune or increase the effectiveness of the MLA. The supplemental data can also be used to improve the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of both the initial and subsequent trained ML model is referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying MLAs, such as, but not limited to, decision trees, random decision forests, neural networks, deep learning (for example, convolutional neural networks), support vector machines, regression (for example, support vector regression, Bayesian linear regression, or Gaussian process regression) may be trained. As another example, size or complexity of a model is varied between different ML models, such as a maximum depth for decision trees, or a number and/or size of hidden layers in a convolutional neural network. Moreover, different training approaches may be used for training different ML models, such as, but not limited to, selection of training, validation, and test sets of training data, ordering and/or weighting of training data items, or numbers of training iterations. One or more of the resulting trained ML models may be selected based on factors such as, but not limited to, accuracy, computational efficiency, and/or power efficiency. In some implementations, a single trained ML model is produced.

The training data may be occasionally updated, and one or more of the ML models used by the system can be revised or regenerated to reflect the updates to the training data. Over time, the training system (whether stored remotely, locally, or both) can be configured to receive and accumulate more training data items, thereby increasing the amount and variety of training data available for ML model training, resulting in increased accuracy, effectiveness, and robustness of trained ML models.

In collecting, storing, using and/or displaying any user data used in training ML models or analyzing documents to generate titles, care is taken to comply with privacy guidelines and regulations. For example, options may be provided to seek consent (e.g., opt-in) from users for collection and use of user data, to enable users to opt-out of data collection, and/or to allow users to view and/or correct collected data.

The system 100 includes a server 120 which is connected to or includes the data store 122 which functions as a repository in which databases relating to training models, document clusters and/or generated titles can be stored. Although shown as a single data store, the data store 122 may be representative of multiple storage devices and data stores which are accessible by one or more of the title generating system 112, training mechanism 114, clustering system 132 and/or client device 150.

The client device 150 is connected to the servers 110, 120 and/or 130 via a network 140. The network 140 may be a conventional type, a wired or wireless network(s) or a combination of wired and wireless networks that connect one or more elements of the system 100. The network 140 may have numerous different configurations including a star configuration, token ring configuration, or other configurations. For instance, the network 140 may include one or more local area networks (LAN), wide area networks (WAN) (e.g., the Internet), public networks, private networks, virtual networks, mesh networks, peer-to-peer networks, and/or other interconnected data paths across which multiple devices may communicate. The network 140 may also be coupled to or include portions of a telecommunications network for sending data in a variety of different communication protocols. In one implementation, the network 140 includes Bluetooth® communication networks or a cellular communications network for sending and receiving data including via short messaging service (SMS), multimedia messaging service (MMS), hypertext transfer protocol (HTTP), direct data connection, WAP, email, and the like.

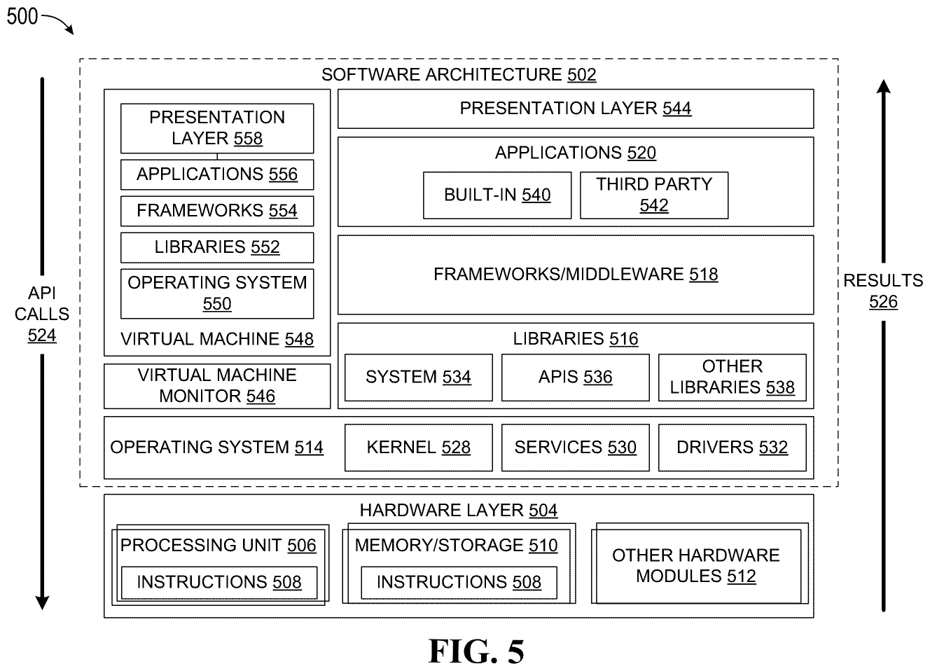

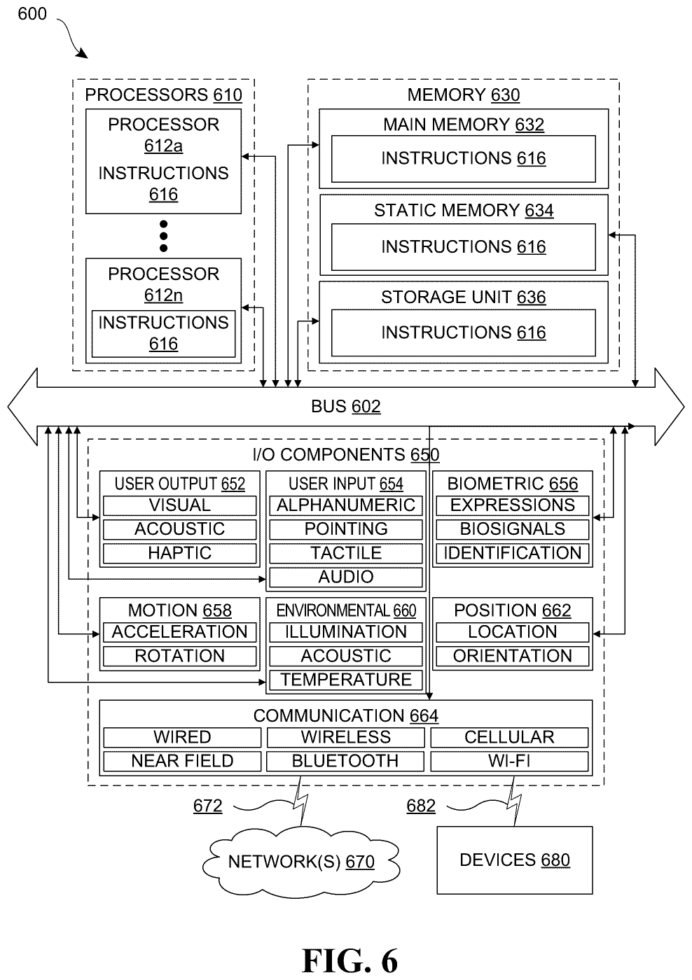

The client device 150 is representative of a plurality of client devices that may be present in the system. The client device 150 includes virtual or physical computer processors, memor(ies), communication interface(s)/device(s), etc., which, along with other components of the client device 150, are coupled to the network 140 via signal lines 142a-142d for communication with other entities of the system 100. For example, the client device 150, accessed by a user 156 via signal lines 142a sends and receives data (e.g., user feedback) to the server 120 and/or the server 130 for storage or clustering. Each client device 150 is a type of personal, business or handheld computing device having or being connected to input/output elements that enable a user to interact with various applications (e.g., application 154). Data from user's interactions with the application 154 may be transmitted in the form of documents to the data store 122 for storage and/or directly to the clustering system 132 for clustering of documents. Examples of suitable client devices 150 include but are not limited to personal computers, desktop computers, laptop computers, mobile telephones, smart phones, tablets, phablets, smart watches, wearable computers, gaming devices/computers, televisions; and the like. The internal hardware structure of a client device is discussed in greater detail with respect to FIGS. 5 and 6.

In some examples, the application a user interacts with to create and transmit documents is executed on the server 110 or another server (e.g., cloud application) and provided via an online service. In some implementations, web applications communicate via the network 140 with a user agent 152, such as a browser, executing on the client devices 150. The user agent 152 may provide a user interface that allows the user to interact with the cloud application. In other implementations, the documents are generated and/or transmitted directly from the user agent (e.g., via a webpage).

Individual documents generated by a user such as the user 156 may be stored in the data store 122 and accessed by the clustering system 132 via signal lines 142a-142d for clustering. Alternatively, the documents are stored in a storage medium within the server 130. The clustering system 132 utilizes known clustering techniques to categorize a number of documents into one or more clusters. The clustering techniques may include analyzing the content of the documents to identify documents that have similar content (e.g., topics, keywords, and the like). In some implementations, the clustering server 130 is not included in the system 100. Instead, documents that are clustered via various mechanisms (e.g., automatically, manually, etc.) are provided to and stored as clusters of documents in a data store such as the data store 122 and are made available for title generation to the title generating system 112.

FIG. 2 depicts an example of some of the elements of a title generating system upon which aspects of this disclosure may be implemented. In some implementations, the title generating system 112 includes a title generating model 210, embedding generating model 220, cluster embedding generating model 230, similarity determination engine 240, and ranking and selection engine 250. Document data 260 is transmitted to the title generation system 112 for processing. The document data 260 may include information about one or more clusters of documents for which a title should be generated. As such, the document data 260 may include the documents in one or more document groups (e.g., a plurality of individual user feedbacks categorized into multiple different user feedback groups). Document data 260 may also include metadata and/or other information about each document group. The document data 260 may be transmitted along with a request for generating a title for one or more groups of documents. Alternatively, once a request for generating a title for a given document group is received, the title generating system 112 retrieves the document data 260 from a storage medium such as the data store 122 of FIG. 1, for processing. As discussed above, the documents in each document groups may be selected by a known clustering mechanism such that each document group in the document data 260 have already been identified as being related.

The individual documents in the document data 260 are transmitted to the title generating model 210 as input for analysis and processing. The title generating model 210 is trained ML model that is trained for analyzing the content of a document, inferring one or more topics or themes from the content and generating a text segment that complies with formatting and stylistic rules and/or guidelines for a document title. The generated titles do not need to contain exact text from the input documents. In some implementations, the length of the generated title cannot exceed a predetermined threshold (e.g., title length cannot be more than 6 words). To generate accurate and/or appropriately worded titles, the title generating model 210 may be trained with a training data set that is similar to the type of documents for which title is being generated. For example, for generating titles for short documents such as user feedbacks (e.g., documents being one to a few sentences long), the training dataset includes titled product reviews.

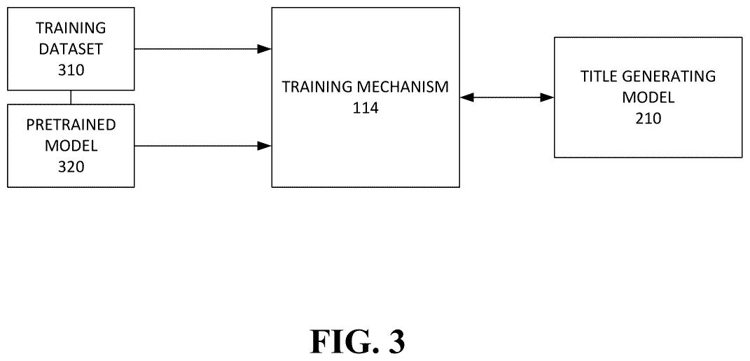

In some implementations, the title generating model 210 is a fine-tuned pretrained model such as a pretrained encoder-decoder or text to text natural language processing (NLP) model which receives text as an input and generates a text as an output. In an example, the title generating model 210 is a fine-tuned T5 model that pairs an encoder architecture, such as, Bidirectional Encoder Representations from Transformers (BERT) with a decoder architecture, such as, Generative Pre-trained Transformer 2 (GPT-2). In other example, a pretrained model that is trained for summarization or translation of text is trained for generating a title for a document. The pretrained model is trained with a training dataset for generating an appropriately worded and formatted title for text documents. The training process is discussed in greater detail with respect to FIG. 3.

The trained title generating model 210 receives and processes each document in a document cluster of the document data 260 to generate a title for each document. The generated titles are then transmitted to the embedding generating model 220 for generating embeddings (e.g., numerical vector representations) for each title. The embedding generating model 220 may be known ML model that is trained and used for generating embeddings from text inputs. In an example, the embedding generating model 220 is a sentence transformer that transforms a sentence or phrase into one or more vector embeddings. For example, the embedding generating model 220 may be a Sentence-BERT (SBERT) model that is trained for receiving a sentence (e.g., a title) as an input and providing semantically meaningful sentence embeddings as an output. In some implementations, a known model such as SBERT is fine-tuned for receiving titles as an input and generating title embeddings as an output.

In addition to generating a title for each document in a document group, from which an embedding is generated, the title generating system may also separately generate an average embedding for the document group as a whole. This is achieved by the cluster embedding generating model 230, which may receive the document data 260 as an input and provide an average embedding for the document group as an output. In some implementations, this is achieved by utilizing a known ML model that is trained for generating embeddings from text inputs such as sentences (e.g., SBERT) to generate one or more embeddings for each document in the document group and then taking an average of the generated embeddings to generate an averaged embedding for the document group. The averaged embedding represents one or more recurring topics or themes of the document group and can be used to ensure that the selected title represents the cluster and not just one of the documents. Thus, the cluster embedding generating model 230 may be a known embedding generating model that receives a plurality of plurality of text documents as input, generates a plurality of embeddings for the input documents and then calculates an average for the generated embeddings.

Once the title embeddings and average cluster embedding are generated, the similarity determination engine 240 is utilized to compare the title embeddings to the average cluster embedding to identify titles that are most closely similar to the average cluster embedding. In some implementations, the similarity determination engine 240 utilizes a cosine similarity measure to calculate the similarities between each generated title and the cluster as a whole. Thus, the similarity determination engine 240 may calculate a similarity score between each generated title and the average cluster embedding.

The calculated similarity scores are transmitted to a ranking and selection engine 250. The ranking and selection engine 250 sorts and/or ranks the generated titles based on their similarity scores. The top one or few titles in the ranked titles are then selected as candidate titles. In an example, the top-ranking title (e.g., the title with the highest similarity score) is selected as the title for the document group and provided as an output 270. In another example, the top N number of titles (e.g., top 3 or top 5) are selected and provided as candidate titles in the output 270. This involves identifying the title(s) that correspond with the embedding(s) having the highest similarity scores and may require examining the title embeddings and their corresponding input titles to retrieve the original title for the embeddings. The selected title(s) are then transmitted as the output 270. The output may be automatically selected and/or for the cluster. Alternatively, the title or top few titles are provided to a user for review and/or selection. In scenarios where the title is presented to a user for selection, feedback relating to the selection may be collected and used for ongoing training of the ML models.

In some implementations, instead of transmitting separate individual documents within a cluster to the title generating system 112, one concatenated document containing multiple individual documents is transmitted. The concatenated document may be generated from multiple individual documents by combining the individual documents into one document. For example, multiple user feedbacks that have been grouped together in one cluster may be combined to generate one user feedback document. The concatenated document is then transmitted to the title generating model 210. In such implementations, the title generating model 210 is trained for generating titles from longer documents that contain multiple shorter text portions (e.g., documents). The title generating model 210 may be trained to generate a title by inferring an overall theme for the document and creating an appropriately phrased title for the theme. In such implementations, since the concatenated document contains the multiple individual documents and the title is generated for the overall document, the processes of creating title embeddings, creating a cluster embedding, similarity determination and ranking and selection may not be required. The title generating model 210 is trained to directly generate a title that is provided as the output 270.

FIG. 3 depicts how the title generating model used by the title generating system 112 is trained by using the training mechanism 114. The training mechanism 114 may use supervised training techniques. The supervised training may make use of labeled training data sets stored in the data store 122 to provide initial and ongoing training to the title generation model 150.

In some implementations, the title generating model 210 is trained using a training dataset 310 which includes existing documents with titles. The documents in the dataset are selected such that they are similar to the types of documents for which the trained title generating model 210 will generate titles. For example, the length, style and/or formatting of the documents in the training dataset 310 may be similar to the length, style and/or formatting of the input documents provided to the trained title generating model 210. In an example, the input documents for the title generating model 210 are user feedbacks and the training dataset 310 includes publicly available and titled user reviews for products and/or services. In other implementations, a custom annotated training dataset is used for training the model. The use of publicly available user reviews is advantageous because they provide a variety of different types of user reviews and corresponding titles that generated manually. This type of data is publicly available, low-cost and easily accessible. In some implementations, to ensure that training dataset 310 is high quality, a manual or automatic review may be performed to ensure that the documents and their corresponding titles adhere to certain guidelines. For example, when the input document to the trained title generating model is restricted to a specific size (e.g., no more than 4000 characters), the collected training data is analyzed to remove documents that are larger in size than the specific size. Other preprocessing steps may be performed on the training data. For example, documents having titles that are directly extracted from or repetitive of the text in the document may be removed. Thus, the training dataset 310 may include a number of titled text documents that are short in length and similar in style to the input documents provided to the title generating model 210.

The resulting training dataset 310 is then used by the training mechanism 114 to train a pretrained model 320 to generate the trained title generating model 210. The pretrained model 320 may be an encoder-decoder model which utilizes a sequence-to-sequence architecture to perform text to text conversion. In an example, the pretrained model 320 is a T5 model. Using the training dataset 310, the pertained model 320 is fine-tuned to receive individual documents as an input and generate an abstractive title as an output. By using a pretrained model, the training process is simplified. Furthermore, by using a pretrained model, the training mechanism 114 is able to train the title generating model 210 with a small training dataset 310 and still obtain high quality titles as an output.

In some implementations, to provide ongoing training, the training mechanism 114 uses training data sets received as out of the ML models. For example, after the model is trained and used, titles generated by the model as well as data relating to their selection may be provided as part of the training data to provide ongoing training. Furthermore, data may be provided from the training mechanism 114 to the data store 122 to update one or more of the training datasets in order to provide updated and ongoing training.

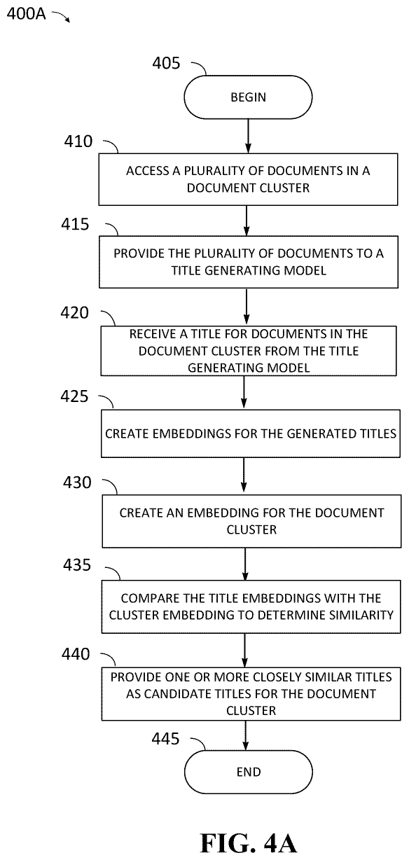

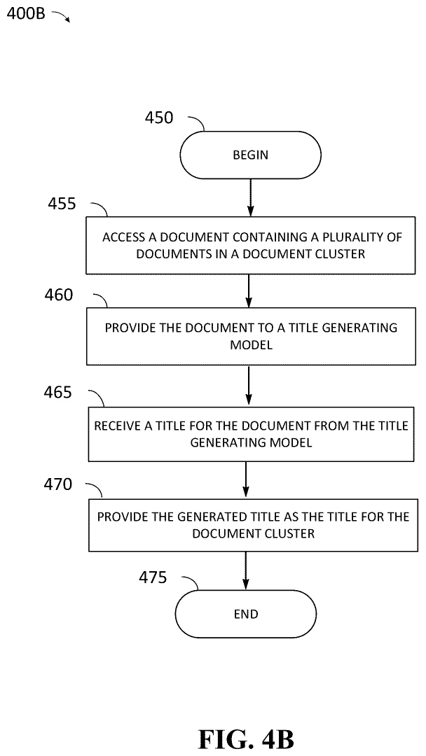

FIG. 4A is a flow diagram depicting an exemplary method for automatically generating a title for a cluster of documents. One or more steps of the method 400A may be performed by a title generating system such as the title generating system 112 of FIGS. 1-2. The method 400A begins at 405 and proceeds to access a plurality of documents in a document cluster, at 410. This may occur, for example, when a clustering mechanism creates a new cluster of documents (e.g., categorizes a number of documents as belonging to a new cluster). In other implementations, a request is submitted to a title generating system, by a clustering mechanism, a document management system and/or a user (e.g., a user reviewing documents) to generate titles for one or more document clusters. The clustering mechanism may categorize the documents based on topic and/or other parameters.

Once the documents in the document cluster are accessed, they are provided to a trained title generating ML model as an input, at 415. The title generating ML model may be a text-to-text NLP model that receives textual documents as an input and generates a title for the document as an output. The title generating ML model may be trained to generate titles that are not directly extracted from the text but are instead abstractive. After providing the documents to the title generating ML model, a title is received from as an output of the title generating ML model for one or more of the documents in the document cluster, at 420. The generated titles are then converted to embeddings, at 425. This may be achieved by utilizing an embedding generating model that converts text to vector embeddings (numerical vector representations of text).

In addition to creating embeddings for titles of the documents in the document cluster, method 400 also generates one or more topic embeddings for the cluster as a whole, at 430. This is achieved, in some implementations, by generating embeddings for various portions of the documents in the cluster (e.g., by sentence, paragraph, etc.) and then generating an average embedding for the cluster based on the individual embeddings. Once the cluster embedding has been generated, method 400 proceeds to compare the title embeddings with the cluster embedding to identify title embeddings that are closely similar to the cluster embedding, at 435. One or more titles associated with closely similar title embeddings are then provided as candidate titles for the document cluster, at 440, before method 400 ends at 445. The candidate titles may be provided to an application for display to a user. The user may have the option of selecting a title from among a group of title candidates. Alternatively, a title is selected automatically and provided as the selected title for the document cluster.

FIG. 4B is a flow diagram depicting an alternative method for automatically generating a title for a cluster of documents. One or more steps of the method 400B may be performed by a title generating system such as the title generating system 112 of FIGS. 1-2. The method 400B begins, at 450, and proceeds to access a document containing a plurality of documents in a document cluster, at 455. This may occur, for example, when a clustering mechanism creates a new cluster of documents (e.g., categorizes a number of documents as belonging to a new cluster) and then creates one or more documents that combine a plurality of the documents into one or more larger documents. This may be done, for smaller documents (e.g., documents containing a few lines of text) that can easily be combined into one or two documents. In other implementations, the documents are transmitted to the title generating system and the title generating system concatenates the documents into one document. The document may be accessed once a request for title generation is received.

Once the document is accessed, it is provided to a trained title generating ML model, at 460. The trained title generating model may be a text-to-text NLP model that receives textual documents as an input and generates a title for the document as an output. The title generating ML model may be trained to generate titles that are not directly extracted from the text but are instead abstractive, and the model may be trained for generating a title for a document that combines a number of related documents (e.g., documents in one cluster) into one document. After providing the document to the title generating ML model, a title is received from as an output of the title generating ML model, at 465. Because the concatenated document already includes multiple documents from the cluster, a cluster embedding is not generated or compared to the generated title in this implementation. Instead, the generated title is directly provided as the title for the cluster, at 470, before method 400B ends, at 475.

In this manner, a title generating model which is trained using publicly available datasets and a pretrained encoder-decoder language model can be used to generate titles for document clusters. The generated titles may be short (e.g., six or fewer words) and abstractive (e.g., do not contain vocabulary or keywords from the original document(s)) and concisely capture the content of the document or cluster. Because training the model is achieved by using a pretrained model and publicly available datasets, the training step does not require an external knowledge base and as such is more efficient and cost effective. Furthermore, the generated titles do not rely on using keywords or extracted spans for title candidates, allowing for more flexibility in outputs. An additional advantage of this approach is that it can be trained in a way that is compliant with privacy guidelines, since the title candidates need not be spans or keywords extracted directly from the documents.

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A data processing system comprising:
   a processor; and
   a memory in communication with the processor, the memory comprising executable instructions that, when executed by the processor, cause the data processing system to perform functions of:
   accessing a plurality of documents, the plurality of documents being documents that have been categorized as belonging to a document cluster;
   providing the plurality of documents as an input to a trained title generating machine-learning (ML) model, the trained title generating ML model being trained for generating a title for a document;
   receiving a plurality of titles from the trained title generating ML model, each of the plurality of titles being a title for one of the plurality of documents;
   creating an embedding for one or more of the plurality of titles;
   creating an embedding for the document cluster;
   measuring a similarity between the embeddings for the one or more of the plurality of titles and embedding for the document cluster to identify titles that are more similar to the embedding for the document cluster;
   selecting, based on the similarity, one or more titles from among the plurality of titles as title candidates for the document cluster; and
   providing the one or more title candidates as an output.
Item 2. The data processing system of item 1, wherein the trained title generating ML model is a trained encoder-decoder language model that generates abstractive titles for a document in the document cluster.
Item 3. The data processing system of items 1 or 2, wherein creating an embedding for one or more of the plurality of titles includes generating numerical vector representations of text for each of the plurality of titles.
Item 4. The data processing system of any preceding item, wherein creating an embedding for the document cluster includes creating an averaged embedding for the document cluster.
Item 5. The data processing system of item 4, wherein creating an averaged embedding includes:
   utilizing a model trained for generating topic embeddings from text inputs to generate one or more embeddings for the plurality of documents in the document cluster; and
   calculating an average of the generated topic embeddings to generate the averaged embedding for the document cluster.
Item 6. The data processing system of any preceding item, wherein measuring the similarity between the embeddings for the one or more of the plurality of titles and embedding for the document cluster includes calculating a similarity score between each of the embeddings for the one or more of the plurality of titles and the embedding for the document cluster.
Item 7. The data processing system of item 6, wherein the title candidates are selected based on the similarity score.
Item 8. A method for automatically generating a title for a cluster of documents comprising:
   accessing a plurality of documents in the document cluster, the plurality of documents being documents that have been categorized as belonging to the document cluster;
   providing the plurality of documents as an input to a trained title generating machine-learning (ML) model, the trained title generating ML model being trained for generating a title for a document;
   receiving a title from the trained title generating ML model for each of the plurality of documents;
   creating an embedding for each of the received titles;
   creating a topic embedding for the document cluster;
   measuring a similarity between each of the embeddings for the received titles and the topic embedding for the document cluster; and
   selecting, based on the similarity, one or more titles from among the received titles as title candidates for the document cluster.
Item 9. The method of item 8, wherein the trained title generating ML model is a trained text to text language model that receives the document as the input and generates the titles for the document as an output.
Item 10. The method of any of items 8 or 9, wherein the trained title generating ML model is trained by using a publicly available labeled dataset to fine-tune a pretrained ML model.
Item 11. The method of item 10, wherein the pretrained ML model is an encoder-decoder deep learning model.
Item 12. The method of any of items 8-11, wherein creating an embedding for each of the received titles includes generating numerical vector representations of text for each of the received titles.
Item 13. The method of any of items 8-12, wherein creating the embedding for the document cluster includes creating an averaged embedding for the document cluster.
Item 14. The method of item 13, further comprising:
   utilizing a model trained for generating topic embeddings from text inputs to generate one or more embeddings for the plurality of documents in the document cluster; and
   calculating an average of the generated topic embeddings to generate the topic embedding for the document cluster.
Item 15. The method of any of items 8-14, wherein measuring the similarity between the embeddings for the one or more of the plurality of titles and embedding for the document cluster includes calculating a similarity score between each of the embeddings for the one or more of the plurality of titles and the embedding for the document cluster.
Item 16. The method of item 15, wherein the title candidates are selected based on the similarity score.
Item 17. A non-transitory computer readable medium on which are stored instructions that, when executed, cause a programmable device to perform functions of:
   accessing a document, the document including content from a plurality of shorter documents, the shorter documents being documents that have been identified as belonging to a document cluster;
   providing the document as an input to a trained title generating machine-learning (ML) model, the trained title generating ML model being trained for generating a title for a document that includes a plurality of shorter documents that belong to the document cluster;
   receiving a title from the trained title generating ML model as an output; and
   providing the title as a cluster title for the document cluster.
Item 17. The non-transitory computer readable medium of claim 17, wherein the trained title generating ML model is a trained text to text language model that receives the document as the input and generates the title for the document cluster as the output.
Item 18. The non-transitory computer readable medium of items 17 or 18, wherein the trained title generating ML model is trained by using a publicly available labeled dataset to fine-tune a pretrained ML model.
Item 20. The non-transitory computer readable medium of any of items 17-19, wherein the document is concatenated to include the documents in the document cluster.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
accessing a plurality of documents, the plurality of documents being documents that have been categorized as belonging to a document cluster;
providing the plurality of documents as an input to a trained title generating machine-learning (ML) model, the trained title generating ML model being trained for generating a title for a document;
receiving a plurality of titles from the trained title generating ML model, each of the plurality of titles being a title for one of the plurality of documents;
creating an embedding for one or more of the plurality of titles;
creating an embedding for the document cluster;
measuring a similarity between the embeddings for the one or more of the plurality of titles and embedding for the document cluster to identify titles that are more similar to the embedding for the document cluster;
selecting, based on the similarity, one or more titles from among the plurality of titles as title candidates for the document cluster; and
providing the one or more title candidates as an output.

2. The data processing system of claim 1, wherein the trained title generating ML model is a trained encoder-decoder language model that generates abstractive titles for a document in the document cluster.

3. The data processing system of claim 1, wherein creating an embedding for one or more of the plurality of titles includes generating numerical vector representations of text for each of the plurality of titles.

4. The data processing system of claim 1, wherein creating an embedding for the document cluster includes creating an averaged embedding for the document cluster.

5. The data processing system of claim 4, wherein creating an averaged embedding includes:
utilizing a model trained for generating topic embeddings from text inputs to generate one or more embeddings for the plurality of documents in the document cluster; and
calculating an average of the generated topic embeddings to generate the averaged embedding for the document cluster.

6. The data processing system of claim 1, wherein measuring the similarity between the embeddings for the one or more of the plurality of titles and embedding for the document cluster includes calculating a similarity score between each of the embeddings for the one or more of the plurality of titles and the embedding for the document cluster.

7. The data processing system of claim 6, wherein the title candidates are selected based on the similarity score.

8. A method for automatically generating a title for a cluster of documents comprising:
accessing a plurality of documents in the document cluster, the plurality of documents being documents that have been categorized as belonging to the document cluster;
providing the plurality of documents as an input to a trained title generating machine-learning (ML) model, the trained title generating ML model being trained for generating a title for a document;
receiving a title from the trained title generating ML model for each of the plurality of documents;
creating an embedding for each of the received titles;
creating a topic embedding for the document cluster;
measuring a similarity between each of the embeddings for the received titles and the topic embedding for the document cluster; and
selecting, based on the similarity, one or more titles from among the received titles as title candidates for the document cluster.

9. The method of claim 8, wherein the trained title generating ML model is a trained text to text language model that receives the document as the input and generates the titles for the document as an output.

10. The method of claim 8, wherein the trained title generating ML model is trained by using a publicly available labeled dataset to fine-tune a pretrained ML model.

11. The method of claim 10, wherein the pretrained ML model is an encoder-decoder deep learning model.

12. The method of claim 8, wherein creating an embedding for each of the received titles includes generating numerical vector representations of text for each of the received titles.

13. The method of claim 8, wherein creating the embedding for the document cluster includes creating an averaged embedding for the document cluster.

14. The method of claim 13, further comprising:
utilizing a model trained for generating topic embeddings from text inputs to generate one or more embeddings for the plurality of documents in the document cluster; and
calculating an average of the generated topic embeddings to generate the topic embedding for the document cluster.

15. The method of claim 8, wherein measuring the similarity between the embeddings for the one or more of the plurality of titles and embedding for the document cluster includes calculating a similarity score between each of the embeddings for the one or more of the plurality of titles and the embedding for the document cluster.

16. The method of claim 15, wherein the title candidates are selected based on the similarity score.

17. A non-transitory computer readable medium on which are stored instructions that, when executed, cause a programmable device to perform functions of:
accessing a document, the document including content from a plurality of shorter documents, the shorter documents being documents that have been identified as belonging to a document cluster;
providing the document as an input to a trained title generating machine-learning (ML) model, the trained title generating ML model being trained for generating a title for a document that includes a plurality of shorter documents that belong to the document cluster;
receiving a title from the trained title generating ML model as an output; and
providing the title as a cluster title for the document cluster.

18. The non-transitory computer readable medium of claim 17, wherein the trained title generating ML model is a trained text to text language model that receives the document as the input and generates the title for the document cluster as the output.

19. The non-transitory computer readable medium of claim 17, wherein the trained title generating ML model is trained by using a publicly available labeled dataset to fine-tune a pretrained ML model.

20. The non-transitory computer readable medium of claim 17, wherein the document is concatenated to include the documents in the document cluster.
